(19) United States
(12) Patent Application Publication
(10) Pub. No.: US 2015/0308753 A1
(43) Pub. Date: Oct. 29, 2015

(54) METHOD FOR PRODUCING A MULTI-LAYER PIPE LINE, PIPE LINE, AND AIR-CONDITIONING SYSTEM HAVING SUCH A PIPE LINE

(71) Applicants: REHAU AG + CO, Rehau (DE); REHAU POLYMERS (SUZHOU) CO LTD., Jiangsu (CN)

(72) Inventors: Dragan GRIEBEL, Shanghai (CN); David HERENSPERGER, Shanghai (CN); Alexander OELSCHLEGEL, Konradsreuth (DE); Karlheinz WINTER, Rehau (DE); Udo STEFFL, Weidenberg (DE); Volker BÖHM, Sparneck (DE)

(21) Appl. No.: 14/648,362

(22) PCT Filed: Nov. 26, 2013
(86) PCT No.: PCT/EP2013/003566

§ 371 Date: May 29, 2015

(30) Foreign Application Priority Data
Nov. 29, 2012 (DE) 10 2012 111 584.2

(51) Int. Cl. F28F 1/00; B29C 47/02; B29C 47/00; F16L 9/147; F16L 58/10

(52) U.S. Cl. CPC F28F 1/00; F16L 9/147; F16L 58/109; B29C 47/0023; B29C 47/021; B29L 2023/225

(57) ABSTRACT

A method for producing a multilayered pipe line, in particular for transporting refrigerant in an air-conditioning system. First, an endless inner layer made of stainless steel having a layer thickness of at most 1 mm, preferably at most 0.5 mm, is provided, which constitutes the inside layer of the pipe line. Then, the endless inner layer is covered, by means of an extrusion process, with a plastic layer that preferably has a layer thickness of at most 7 mm, in particular at most 5 mm.

The invention relates to a method for producing a pipe line, which is in particular used for transporting refrigerant in an air-conditioning system.

Refrigerants that are usually used in in air-conditioning systems must fulfill a number of requirements. On the one hand, they must have a vapor pressure curve that permits the refrigerant to absorb and release the greatest possible quantity of heat at the corresponding operating temperatures. In addition, the refrigerant must be harmless to human health. Finally, gases of the refrigerant that may escape from the air-conditioning system must not have a damaging influence on the climate, and, in particular, the refrigerants must be CFC-free. The chemical industry has developed corresponding refrigerants, which have also proven themselves in practice. One example of a refrigerant that is commonly used in practice is R-410A. R-410A is composed of a mixture of R-32 (difluoromethane) and R-125 (pentafluoroethane). The refrigerants currently used in practice at least largely fulfill the above requirements, but have a comparatively high chemical aggressiveness.

According to the prior art, copper pipes are regularly used as transmission lines for corresponding refrigerants in air-conditioning systems. These copper pipes, however, are not entirely chemically resistant to the established refrigerants that are currently in use. Corrosion of the copper pipes can thus occur after the air-conditioning system has been operated for a certain period of time. On the one hand, this involves the risk of a failure of the copper pipes. On the other hand, the corrosion can also produce highly toxic substances such as phosgene. This is emphasized in detail, for example, in the expert article “Ant-Nest Corrosion of Copper Tubing in Air-Conditioning Units,” Journal of Metallurgy [Revista de Metallurgia], 42 (5), September-October, pages 367 through 381, 2006, ISSN: 0034-8570. The use of copper pipes for refrigerants in air-conditioning systems is thus problematic for two different reasons. When they are used, corrosion particularly occurs at the ends of the copper pipes, which are connected to corresponding connection points of the air-conditioning system components.

Another disadvantage of the copper pipes used in the prior art is that they are rigid and thus for transport reasons, their length is limited to a maximum of only a few meters. In air-conditioning systems installed in buildings, it is therefore regularly necessary to assemble the pipe line from a large number of straight pipe line lengths and elbows by means of flange joints. This makes the installation of air-conditioning systems very complex and expensive. In addition, the flange joints in particular are especially susceptible to corrosion.

In light of this situation, the object of the invention is to disclose a method for producing a pipe line, which is in particular used for transporting refrigerant in an air-conditioning system, which has a high corrosion resistance and is also simple and inexpensive to install.

According to the invention, the object is attained by means of a method for producing a multilayered pipe line, in particular for transporting refrigerant in an air-conditioning system, wherein
first, an endless layer made of stainless steel having a layer thickness of at most 1 mm, preferably at most 0.5 mm, is provided, which constitutes the inside layer of the pipe line, and
then, the endless inner layer is covered, by means of an extrusion process, with a plastic layer that preferably has a layer thickness of at most 7 mm, in particular at most 5 mm.

In the finished pipe line, the stainless steel layer which advantageously covers the entire surface constitutes the inner layer and is correspondingly acted on by the medium that is to be transported. According to the invention, therefore, no copper is used in the production of the pipe line. Instead, a thin inner layer of stainless steel that covers the entire surface is produced, which is highly corrosion-resistant in relation to the conventional refrigerants currently in use. Correspondingly, with a pipe line that is produced with the teaching according to the invention, there is no risk of corrosion let alone the generation of toxic substances, both of which are to be expected with the use of copper pipes. The teaching according to the invention also has significant advantages in comparison to the use of a conventional stainless steel pipe line. On the one hand, the low layer thickness results in a low material consumption of expensive stainless steel since the mechanical stability is provided by the endless plastic covering. At the same time, the pipe line produced according to the invention, due to the dimensioning of the two layer thicknesses, has a high enough degree of flexibility to permit a pipe line installation with small bending radii. The pipe line according to the invention can therefore be bent one or more times with an inner bending radius of at most 2 m, e.g. at most 1 m, in particular at most 0.50 m, particularly preferably at most 0.2 m, and quite particularly preferably at most 0.1 m, by at least 15°, e.g. at least 30°, in particular at least 60°, preferably at least 90° without buckling. Thanks to the possibility of endless production of the pipe line according to the invention and the simultaneously high bending flexibility, it is possible to provide a seamless connection between individual system components of an air-conditioning system by means of the pipe line without having to produce flange joints for this purpose in order to connect individual pipe line lengths, elbows, or the like. This permits a particularly quick and inexpensive installation of the pipe line according to the invention. The term “endless” means that the pipe line and thus also the layers of the pipe line can have an almost unlimited length, for example the pipe line can be wound onto a transport drum, for example in a length of at least 20 m, e.g. at least 50 m, or also at least 100 m.

The inner layer is advantageously produced from an endless stainless steel belt that is wrapped axially into a tubular form, with the edges that are adjacent to one another being continuously welded to one another in the longitudinal direction. In this case, therefore, it is only necessary to provide one weld seam extending parallel to the axis of the pipe line, thus achieving advantages from a process standpoint. Alternatively to this, the inner layer can also be produced from a helically wound endless stainless steel belt, with the edges that are adjacent to one another being continuously welded to one another. This likewise permits a comparatively simple and therefore inexpensive production of the endless, fluid-tight stainless steel inner layer.

The edges that are adjacent to one another can be welded to each other with a butt joint, i.e. the edges are positioned directly against each other and joined to each other by the weld seam. In the context of the invention, however, it is also possible to weld the edges with a lap joint. In order to produce the inner layer, the stainless steel belt can be wound onto an arbor that is removed after the welding procedure. This ensures an exact, for example cylindrical, geometry of the inner layer and also significantly simplifies the welding procedure.

An inner layer is advantageously produced with a layer thickness of at most 0.3 mm to ensure the lowest possible consumption of stainless steel. On the other hand, the thickness of the stainless steel inner layer is advantageously at least 0.02 mm, e.g. at least 0.04 mm. In particular, this ensures the diffusion impermeability of the inner layer. The layer thickness of the plastic layer is advantageously at least 1 mm, e.g. at least 2 mm, in order to provide a sufficient stability of the pipe line. On the other hand, the layer thickness of the plastic layer is at most 4 mm, in particular at most 3 mm, in order to ensure favorable flexibility of the pipe line.

The inner layer can be encased with a plastic layer composed of polyethylene, in particular cross-linked polyethylene. Alternatively, however, it is also possible to produce the plastic layer out of an HDPE. This does not, however, rule out the use of other plastic materials such as polypropylene.

The stainless steel inner layer advantageously has an inner diameter of 3 to 20 mm, particular from 5 to 15 mm. This diameter then also corresponds to the diameter of the free flow cross-section of the pipe line.

In the context of the invention, “stainless steel” in particular means a steel according to the EN 10020 standard and is a term used for alloyed and unalloyed steels with a particular degree of purity, e.g. steels whose sulfur- and phosphorus content does not exceed 0.025%. The stainless steel advantageously contains at least 10 wt. % chromium. Examples for suitable stainless steels are material numbers 1.4003, 1.4006, 1.4016, 1.4021, 1.4104, 1.4301, 1.4305, 1.4306, 1.4307, 1.4310, 1.4316, 1.4401, 1.4404, 1.4440, 1.4435, 1.4452, 1.4462, 1.4541, 1.4571, 1.4581 1.4841, and 1.7218. In particular, it is possible in a very general way to use stainless steels according to the EN 10027-2 standard in the form of unalloyed or also alloyed steels. Suitable qualities are, for example, 304, 304L, and 444.

In the context of the invention, it is in particular also possible to provide an adhesion promoter between the inner layer and the plastic layer. This adhesion promoter layer strengthens the bond between the two above-mentioned layers and at the same time, advantageously improves the bending stability of the pipe line. A maleic acid anhydride (MAH), a methyl methacrylate (MMA), or also an epoxy-modified polyethylene or polypropylene can be used as the material for the adhesion promoter layer. It is also conceivable to use mixtures of two or more of the above-mentioned materials. The adhesion promoter layer can be applied to the inner layer using an extrusion process before the application of the plastic layer.

In addition to the method described above, another subject of the invention is a pipe line that is produced using such a method.

Another subject of the invention is an air-conditioning system having a plurality of system components that are spaced apart from one another, a fluid refrigerant that circulates between the system components during operation of the air-conditioning system, and at least one pipe line that is produced according to the invention, which connects the system components and is used for transporting the refrigerant between the system components. The pipe line in this case can have a length of at least 1 m, e.g. at least 5 m, in particular at least 10 m. The pipe line advantageously produces a seamless connection between the system components. This is possible because of the endless nature of the pipe line and because of its high bending flexibility. It is therefore not usually necessary to produce connections to extender elements or curves or the like. The pipe line that is installed in the air-conditioning system is bent one or more times with an inner bending radius of at most 2 m, e.g. at most 1 m, in particular at most 0.50 m, by at least 5°, e.g. at least 15°, and in particular at least 30°.

The pipe line can be flared in order to connect it to a system component. This is easily possible thanks to the low layer thicknesses of the stainless steel layer and plastic covering. The flared pipe line end advantageously encloses a conically embodied connection fitting of the system component and is press-fitted to the latter. This permits a very quick and therefore inexpensive attachment of the pipe line to the system components. The invention will be explained in detail below in conjunction with drawings that show only one exemplary embodiment. The drawings schematically depict the following:

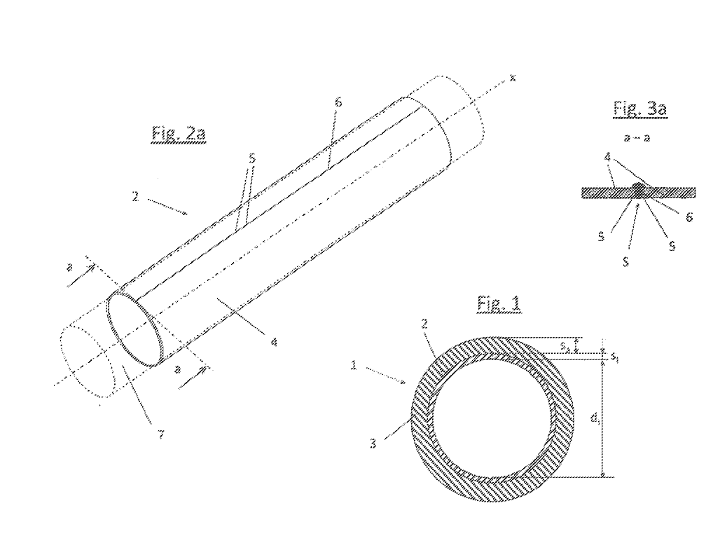

FIG. 1 shows a cross-section through a pipe line produced according to the invention,

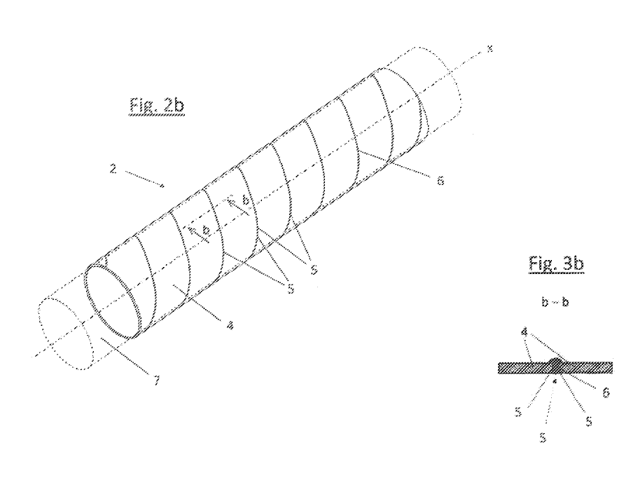

FIGS. 2a and 3a show a method according to the invention for producing an inner layer of a pipe line,

FIGS. 2b and 3b show an alternative production method for the inner layer of the pipe line,

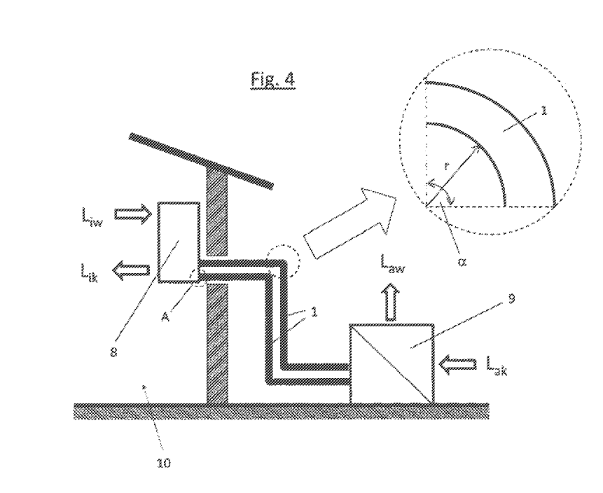

FIG. 4 is an enlarged depiction of an air-conditioning system equipped with a pipe line according to the invention, and

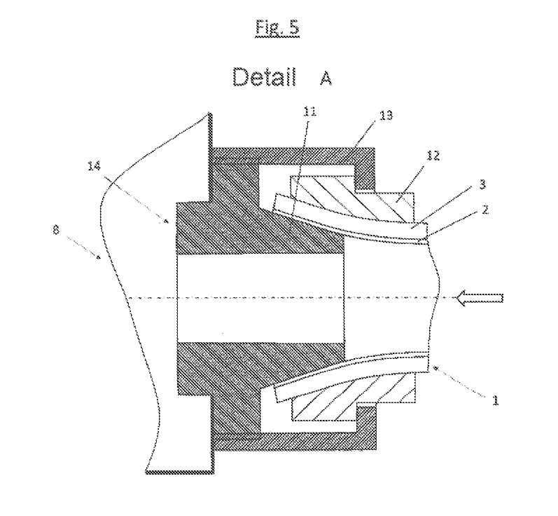

FIG. 5 shows an enlarged view of the detail A indicated in FIG. 4.

FIG. 1 is a cross-sectional depiction of a pipe line 1 produced according to the invention. The pipe line 1 has an endless inner layer 2 composed of stainless steel with a layer thickness of sᵢ=0.2 mm (shown in exaggerated form). The stainless steel inner layer 2 is embodied as covering the entire area so that it defines a closed inner surface of the pipe line 1 and constitutes the inner layer of the finished pipe line 1. The stainless steel inner layer 2 is covered by a plastic layer 3 composed of cross-linked polyethylene that is applied by means of an extrusion process and is therefore likewise endless, with a layer thickness of sₐ=3 mm. The inner diameter dᵢ of the stainless steel inner layer 2 in the exemplary embodiment is 10 mm. It simultaneously defines the free flow cross-section of the pipe line 1.

In the method for producing the inner layer 2 according to FIG. 2a, the inner layer 2 is produced from an endless stainless steel belt 4 that is wrapped axially into a tubular form, with the edges 5 that are adjacent to one another being continuously welded to one another in the longitudinal direction x. FIG. 3a shows a detail of the axial section a-a according to FIG. 2a. In this case, it is clear that the edges 5 of the stainless steel belt 4 that are adjacent to each other due to the tubular form that is produced are welded to each other with a butt joint S in the axial direction x. In other words, the edges 5 are positioned next to each other and are connected to each other by means of a continuous weld seam 6 extending in the axial direction x. In order to produce the inner layer 2, the endless stainless steel belt 4 as is clear from FIG. 2a—is wound in a tubular form onto an arbor 7 (depicted with dashed lines), which is removed after the welding procedure. The stainless steel inner layer 2 is encased with the plastic layer 3 shown in FIG. 1 by means of the above-mentioned extrusion process. It should be noted at this point that the weld seam 6 is not shown in FIG. 1. An adhesion promoter layer (not shown) can be optionally applied to the stainless steel inner layer 2 before the application of the plastic layer 3 in order to improve the bonding of the plastic layer 3 to the stainless steel inner layer 2 in the extrusion process. This adhesion promoter layer can be composed of an MAH, an MMA, or an epoxy-modified polyethylene or polypropylene.

In an alternative production method according to FIG. 2b, the inner layer 2 is produced from a helically wound endless stainless steel belt 4, with the adjacent helical edges 5 being welded completely to each other. FIG. 3b shows a detail of the radial section b-b from FIG. 2b. It is clear that here, too, the corresponding edges 5 of the stainless steel belt 4 that are adjacent to each other are welded to each other with a butt joint S. In other words, in this case, the edges 5 are positioned next to each other and are joined to each other by means of a continuous helical weld seam 6. In order to produce the inner layer 2, the stainless steel belt 4 here—as shown in FIG. 2b—is likewise wound onto an arbor 7, which is removed after the welding procedure. The stainless steel inner layer 2 is then extrusion coated in the same way with the plastic layer 3 shown in FIG. 1.

FIG. 4 shows an air-conditioning system with a plurality of system components 8, 9 that are spaced apart from one another, with one system component 8 being an internal module of the air-conditioning system and another system component being the external module 9 of the air-conditioning system. The inner module 8 is installed inside a building 10, while the external module 9 is installed in the open air. Warm building air L_{iw} flows into the internal module 8, is cooled there, and exits the internal module 8 as cooled building air Lᵢₖ. At the same time, exterior air Lₐₖ is drawn into the external module 9, which exits the external module 9 as heated air L_{aw}. Between the external module 9 and the internal module 8, two pipe lines 1 are provided, which have been produced according to the method described in conjunction with FIGS. 1 through 3. The pipe lines 1 fluidically connect the external module 9 to the internal module 8 and are used to transport a fluid refrigerant, which circulates between the internal module 8 and the external module 9. In the exemplary embodiment, the pipe lines 1 have a length of at least 5 m. FIG. 4 also shows that the pipe lines 1 produce a seamless connection between the system components 8 and 9, i.e. the pipe lines 1 are each positioned as a one-piece element between the system components. This is ensured by the endless nature of the pipe lines 1 and in particular also by means of their high-flexibility pipe line. The enlarged detail shown in FIG. 4 shows that the two pipe lines 1 are each bent there by an angle α=90°; the bending radius r being only 20 cm. This permits a space saving installation without having to resort to a complex installation of pipe line elbows or the like. For installation, the pipe lines 1 are simply cut to length from a “parent pipe line” supplied in a roll on a transport drum (not shown) and then installed, The lengths of the pipe lines 1 in this case are dimensioned so that they reach from the internal module 8 to the external module 9.

FIG. 5 shows an enlarged depiction of the connection of a pipe line end to a system component, in this case the internal module 8. It is clear that the pipe line 1 is flared at the end in order to be connected to the internal module 8. The flared pipe line end encompasses a conically embodied connection fitting 11 of the system component 8 and is press-fitted to the latter. The press-fit is produced by means of a support sleeve or clawed sleeve 12 resting against the pipe line end, which can have an inner structure that is not shown, e.g. in the form of ridges, teeth, or the like. The sleeve 12 is connected by means of a union nut 13 to a fitting element 14 of the system component 8 onto which the connecting fitting 11 is formed, which in the exemplary embodiment is embodied as conical. The scope of the invention, however, also includes a two-part embodiment in which the support element and connection fitting are two separate elements that are attached to each other. All that is needed to produce the connection, therefore, is to screw the union nut 13 onto the support element 14. The support sleeve or clawed sleeve 12 then cooperates with the conical connection fitting 11 to produce a fluid-tight connection of the pipe line end to the system component 8.

1. A method for producing a multilayered pipe line, in particular for transporting refrigerant in an air-conditioning system, wherein
first, an endless inner layer made of stainless steel having a layer thickness of at most 1 mm, preferably at most 0.5 mm, is provided, which constitutes the inside layer of the pipe line, and
then, the endless inner layer is covered, by means of an extrusion process, with a plastic layer that preferably has a layer thickness of at most 7 mm, in particular at most 5 mm.

2. The method according to claim 1, wherein the inner layer is composed of an endless stainless steel belt that is wrapped axially into a tubular form, with the edges that are adjacent to one another being continuously welded to one another in the longitudinal direction.

3. The method according to claim 1, wherein the inner layer is produced from a helically wound endless stainless steel belt, with the edges that are adjacent to one another being continuously welded to one another.

4. The method according to claim 2, wherein the edges that are adjacent to each other are welded to each other with a butt joint.

5. The method according to claim 2, wherein the stainless steel belt is wound onto an arbor that is removed after the welding procedure.

6. The method according to claim 1, wherein an inner layer is produced with a layer thickness of at most 0.3 mm.

7. The method according to claim 1, wherein an inner layer is produced with an inner diameter of 3 to 20 mm.

8. The method according to claim 1, wherein a stainless steel with a chromium content of at least 10 wt. % is used for the inner layer.

9. The method according to claim 1, wherein the inner layer is encased with a plastic layer composed of polyethylene, in particular cross-inked polyethylene.

10. A pipe line, produced with a method according to claim 1.

11. An air-conditioning system having
a plurality of system components spaced apart from one another,
a fluid refrigerant that circulates between the system components during operation of the air-conditioning system, and
at least one pipe line that is produced according to the invention, which connects the system components and is used for transporting the refrigerant between the system components.

12. The air-conditioning system according to claim 11, wherein the pipe line has a length of at least 1 m.

13. The air-conditioning system according to claim 11, wherein the pipe line produces a seamless connection between den system components.

14. The air-conditioning system according to claim 11, wherein the pipe line is bent one or more times with a bending radius of at most 2 m, by an angle (α) of at least 5°.

15. The air-conditioning system according to claim 10, wherein the pipe line is flared at the end in order to be connected to a system component.

16. The air-conditioning system according to claim 15, wherein the flared pipe line end encloses a conically embodied connection fitting of the system component and is press-fitted to the latter.

17. The method according to claims 1, wherein an inner layer is produced with an inner diameter of 5 to 15 mm.

18. The air-conditioning system according to claim 11, wherein the pipe line has a length of at least 5 m.

19. The air-conditioning system according to claim 11, wherein the pipe line has a length of at least 10 m.

20. The air-conditioning system according to claim 11, wherein the pipe line is bent one or more times with a bending radius of at most 1 m, by an angle (α) of at least 5°.

21. The air-conditioning system according to claim 11, wherein the pipe line is bent one or more times with a bending radius of at most 50 cm, by an angle (α) of at least 5°.

22. The air-conditioning system according to claim 11, wherein the pipe line is bent one or more times with a bending radius of at most 1 m, by an angle (α) of at least 150°.

23. The air-conditioning system according to claim 11, wherein the pipe line is bent one or more times with a bending radius of at most 1 m, by an angle (α) of at least 30°.

24. The air-conditioning system according to claim 11, wherein the pipe line is bent one or more times with a bending radius of at most 50 cm, by an angle (α) of at least 150°.

25. The air-conditioning system according to claim 11, wherein the pipe line is bent one or more times with a bending radius of at most 50 cm, by an angle (α) of at least 30°.

26. The air-conditioning system according to claim 11, wherein the pipe line is bent one or more times with a bending radius of at most 2 m, by an angle (α) of at least 150°.

27. The air-conditioning system according to claim 11, wherein the pipe line is bent one or more times with a bending radius of at most 2 m, by an angle (α) of at least 30°.
